(19) United States
(12) Patent Application Publication
(10) Pub. No.: US 2018/0294074 A1
(43) Pub. Date: Oct. 11, 2018

(54) INSULATING RESIN COMPOSITION AND INSULATED ELECTRIC WIRE

(71) Applicant: SUMITOMO ELECTRIC INDUSTRIES, LTD., Osaka (JP)

(72) Inventors: Shigeyuki TANAKA, Osaka (JP); Taro FUJITA, Osaka (JP); Shinya NISHIKAWA, Osaka (JP); Atsuko SHINOMIYA, Tochigi (JP); Yuji OCHI, Tochigi (JP)

(73) Assignee: SUMITOMO ELECTRIC INDUSTRIES, LTD.

(21) Appl. No.: 16/009,010

(22) Filed: Jun. 14, 2018

Related U.S. Application Data
(62) Division of application No. 15/125,693, filed on Sep. 13, 2016.

(30) Foreign Application Priority Data
Apr. 16, 2014 (JP) 2014-084631

(51) Int. Cl. H01B 7/29; H01B 7/295; H01B 3/44

(52) U.S. Cl. CPC H01B 7/292; H01B 7/295; H01B 3/447; H01B 3/441

(57) ABSTRACT

Provided is an insulated electric wire that mainly contains a polyolefin resin, has excellent flexibility, heat life, and waterproofness, and is used in wiring of vehicles such as automobiles, and an insulating resin composition used in forming an insulating layer of this insulated electric wire. The insulating resin composition contains a first copolymer, which is a copolymer of ethylene and an unsaturated hydrocarbon having 4 or more carbon atoms and which has a density less than 0.88 g/cm³, a second copolymer which is a copolymer of ethylene and an acrylic acid ester or a methacrylic acid ester, a flame retardant, and a crosslinking aid. Also provided is a crosslinked body having a 2% secant modulus of 35 MPa or less at room temperature and an elastic modulus of 2 MPa or more at 150° C.

### TECHNICAL FIELD

The present invention relates to an insulated electric wire used in wiring in vehicles etc., and an insulating resin composition and a crosslinked body used as a material of an insulating layer of the insulated electric wire.

### BACKGROUND ART

Insulated electric wires for wiring in vehicles such as automobiles and insulating materials that compose insulating layers of the insulated electric wires are required to have heat-aging resistance (long-term heat resistance and heat life) that prevents deterioration for a long time even in a high-temperature environment such as when heat is generated during energization or the like, flexibility (routing ease) that facilitates handling and enables routing in a small space for space conservation, etc. When an insulated electric wire is used by processing its terminal into a connector, the insulating material is compression-deformed by using a rubber ring or the like so that the repulsive force generated thereby prevents water outside from entering the connecting portion. In order to ensure this waterproof performance, the insulating material is required to have creep deformation resistance. In order to meet these needs, various insulating materials have been proposed.

For example, silicone rubber and EP rubber are known as insulating materials having excellent flexibility. Silicone rubber has high heat resistance and good creep deformation resistance. However, it has disadvantages such as low mechanical strength, high raw material cost, poor oil resistance, possibility of contact faults due to low-molecular-weight siloxane components, etc. EP rubber has satisfactory mechanical strength but has problems concerning heat resistance and creep deformation resistance. Moreover, since a crosslinking reaction involving heating is necessary, the cost of extrusion working is high, which is also a problem.

Polyolefin resins, which are inexpensive and have good extrudability, are also known as insulating materials for insulated electric wires. In general, flexible polyolefin resins have inferior creep deformation resistance and the like. To address this issue, proposals regarding modification of polyolefin resins and resin compositions prepared by blending other resins have been made.

For example, PTL 1 discloses a halogen-free resin composition that contains a base resin constituted by a polypropylene resin, a propylene-α olefin copolymer, and a low-density-polyethylene resin, a metal hydrate, a phenolic antioxidant, and a hydrazine metal scavenger. Also disclosed are an insulated electric wire having an insulating coating formed of this resin composition, and a wire harness that includes this insulated electric wire. The insulated electric wire and the wire harness are described as having improved mechanical properties such as abrasion resistance, flame retardancy, etc., as well as improved flexibility and long-term heat resistance (paragraphs 0013 and 0014).

PTL 1: Japanese Unexamined Patent Application Publication No. 2009-127040

### SUMMARY OF INVENTION

### Technical Problem

Cables used for connecting batteries, inverters, and motors (power systems) of motor-driven automobiles such as hybrid cars, electric cars, fuel-cell cars, etc., which have recently been developed desirably have conductors with large diameters in order to allow for higher voltage and higher current. However, known insulated electric wires (wire harnesses) such as insulated electric wires (wire harnesses) described in PTL 1 are difficult to route due to insufficient flexibility if their diameters are increased. Moreover, in order to manage generation of a large quantity of heat due to high current, further improvements in heat resistance are desirable.

An object of the present invention is to provide an insulating resin composition and a crosslinked body capable of forming an insulating layer that has flexibility and heat-aging resistance both good enough to meet the above-described recent needs, and creep deformation resistance that can ensure sufficient waterproof performance (terminal waterproofness). Another object of the present invention is to provide an insulated electric wire (including an insulated cable) that has an insulating layer formed of the insulating resin composition or the crosslinked body.

### Solution to Problem

The inventors of the present invention have conducted extensive investigations to achieve the objects described above.

As a result, the inventors have found that when an insulating layer is formed by using an insulating resin composition mainly containing a polyolefin resin which is a copolymer of ethylene and an unsaturated hydrocarbon having 4 or more carbon atoms and has a density less than 0.88, or a mixture of this polyolefin resin and a copolymer of ethylene and an acrylic acid ester or a methacrylic acid ester and when this resin is crosslinked by irradiation with ionizing radiation or the like, good flexibility that enables easy routing can be obtained, crosslinking proceeds efficiently, elastic modulus at high temperature is increased, creep deformation resistance is improved, good waterproof performance (terminal waterproofness) is obtained, and long-term heat resistance (heat life) is improved. The inventors have also found that when an insulator that has a 2% secant modulus of 35 MPa or less at room-temperature and an elastic modulus of 2 MPa or more at 150° C. is used, flexibility and waterproof performance are enhanced, and thus made the invention whose embodiments are described below.

A first embodiment of the present invention is an insulating resin composition comprising:

a resin comprising a first copolymer and a second copolymer at a first copolymer-to-second copolymer ratio (mass ratio) of 100:0 to 40:60,
the first copolymer being a copolymer of ethylene and an unsaturated hydrocarbon having 4 or more carbon atoms, and having a density less than 0.88 g/cm³,
the second copolymer being a copolymer of ethylene and an acrylic acid ester or a methacrylic acid ester; and

30 to 100 parts by mass of a flame retardant and 1 to 5 parts by mass of a crosslinking aid relative to 100 parts by mass of the resin.

A second embodiment of the present invention is a crosslinked body prepared by crosslinking a resin composition mainly containing a polyolefin resin, in which the crosslinked body has a 2% secant modulus of 35 MPa or less at room temperature, and an elastic modulus of 2 MPa or more at 150° C.

A third embodiment of the present invention is an insulated electric wire comprising a conductor and an insulating layer covering the conductor either directly or with another layer therebetween, in which the insulating layer is formed of the insulating resin composition according to the first embodiment and the resin is crosslinked, or the insulating layer is formed of the crosslinked body according to the second embodiment.

### Advantageous Effects of Invention

The first embodiment of the present invention provides an insulating resin composition used for forming an insulating layer of an insulated electric wire that has good flexibility enabling easy routing, excellent waterproof performance, and excellent long-term heat resistance (heat life).

The second embodiment of the present invention provides a crosslinked body that forms an insulating layer of an insulated electric wire that has good flexibility enabling easy routing, excellent waterproof performance, and excellent long-term heat resistance (heat life).

The third embodiment of the present invention provides an insulated electric wire that has good flexibility enabling easy routing and excellent long-term heat resistance (heat life).

### BRIEF DESCRIPTION OF DRAWINGS

FIG. 1 is a perspective view of a structure of an example (shield electric wire) of an insulated electric wire.

FIG. 2 is a diagram showing a method for measuring flexibility of an insulated electric wire.

### DESCRIPTION OF EMBODIMENTS

Next, embodiments of the present invention are specifically described. The embodiments do not limit the scope of the present invention and can be modified and altered without departing from the gist of the present invention.

A first embodiment of the present invention is an insulating resin composition comprising:

a resin comprising a first copolymer and a second copolymer at a first copolymer-to-second copolymer ratio (mass ratio) of 100:0 to 40:60,
the first copolymer being a copolymer of ethylene and an unsaturated hydrocarbon having 4 or more carbon atoms, and having a density less than 0.88 g/cm³,
the second copolymer being a copolymer of ethylene and an acrylic acid ester or a methacrylic acid ester; and

30 to 100 parts by mass of a flame retardant and 1 to 5 parts by mass of a crosslinking aid relative to 100 parts by mass of the resin.

When the insulating resin composition of the first embodiment is used to form an insulating layer of an insulated electric wire and the resin is crosslinked by irradiation with ionizing radiation or the like, an insulated electric wire which has good flexibility enabling easy routing, and excellent long-term heat resistance (heat life) can be produced. When a terminal is used as a connector, an insulated electric wire that exhibits good waterproof performance (terminal waterproofness) is provided.

The first copolymer contained in the insulating resin composition is a polyolefin resin which is a copolymer of ethylene and an unsaturated hydrocarbon having 4 or more carbon atoms, and which has a density less than 0.88 g/cm³. A copolymer of ethylene and an unsaturated hydrocarbon having 3 or less carbon atoms rarely achieves good heat life, good creep deformation resistance, and waterproof performance. It is difficult to obtain flexibility that satisfies the recent needs if a resin having a density of 0.88 g/cm³or more is used as the first copolymer. Moreover, since crosslinking of the resin rarely proceeds efficiently, elastic modulus at high temperature (for example, 150° C.) is low.

Examples of the polyolefin resin include ethylene-butene copolymers (EB) and ethylene-octene copolymers (EO). Among these, EB, which strikes an excellent balance between flexibility, heat life, and creep deformation resistance, is preferable. Thus, a preferable embodiment is an embodiment in which the first copolymer is EB.

A commercially available product can be used as the first copolymer. Examples of EB include ENGAGE 7467 (produced by the Dow Chemical Company, density: 0.862) and TAFMER DF710 (produced by Mitsui Chemicals, Inc., density: 0.870). An example of EO is ENGAGE 8842 (produced by the Dow Chemical Company, density: 0.857).

The first copolymer may be blended with the second copolymer described above. Blending with the second copolymer is preferable since heat life can be improved.

The second copolymer is selected from the group consisting of an ethylene-acrylic acid ester copolymer and an ethylene-methacrylic acid ester copolymer. Specific examples thereof include ethylene-methyl acrylate, ethylene-ethyl acrylate, ethylene-butyl acrylate, ethylene-methyl methacrylate, ethylene-ethyl methacrylate, and ethylene-butyl methacrylate.

Among these, an ethylene-ethyl acrylate copolymer (EEA) is preferable from the viewpoints of flexibility and heat resistance, and this copolymer preferably has an ethyl acrylate (EA) ratio of 20% or more. Thus, a preferable embodiment is an embodiment in which the second copolymer is EEA. As EEA, commercially available products may be used such as DFDJ 6182 and NUC-6510 (produced by Nippon Unicar Company Limited, EA ratio: 23%), NUC-6520 (produced by Nippon Unicar Company Limited, EA ratio: 24%), and DPDJ-6182 (produced by Nippon Unicar Company Limited, EA ratio: 15%).

The amount of the second copolymer blended is within such a range that the ratio (mass ratio) of the first copolymer to the second copolymer is 100:0 to 40:60. Good flexibility (low flexural rigidity) and good waterproof performance are obtained within this range. When the ratio of the mass of the second copolymer to the total mass of the first copolymer and the second copolymer exceeds 60% (that is, when the ratio of the first copolymer is less than 40%), flexural rigidity is high and good flexibility is not obtained. Moreover, the 2% secant modulus exceeds 35 MPa, the elastic modulus at 150° C. decreases to less than 2 MPa, and the ratio of the elastic modulus at 150° C. to the elastic modulus at 180° C. exceeds 1.2. As a result, creep deformation resistance is degraded and good waterproof performance is no longer obtained.

The ratio of the first copolymer to the second copolymer is preferably within the range of 80:20 to 40:60 (mass ratio). In other words, the ratio of the mass of the first copolymer to the total mass of the first copolymer and the second copolymer is preferably 80% or less (in other words, the ratio of the second copolymer is 20% or more). Recently, there have been an increasing number of instances where the continuous heat resistance temperature (heat life prescribed in standards of Japanese Automotive Standards Organization (JASO)) at which a 100% elongation is obtained for insulators exposed to 10,000 hours of heating is required to be 150° C. or higher. When the mass ratio of the first copolymer is 80% or less, good heat resistance that fulfils this requirement is obtained. Thus, an embodiment in which the ratio of the first copolymer to the second copolymer is 80:20 to 40:60 (mass ratio) is provided.

A flame retardant is added to the insulating resin composition of the first embodiment in order to improve flame retardancy of the insulated electric wire. The flame retardant content in the resin composition is 30 to 100 parts by mass relative to the 100 parts by mass of the resin. At a flame retardant content less than 30 parts by mass, sufficient flame retardancy is not obtained. A flame retardant content exceeding 100 parts by mass is not preferable since mechanical strength of the insulating layer decreases.

Examples of the flame retardant include magnesium hydroxide, aluminum hydroxide, bromine flame retardants, antimony trioxide, antimony pentaoxide, and zinc borate. These flame retardants can be used alone or in combination. However, magnesium hydroxide and aluminum hydroxide require a high filling amount in order to obtain sufficient flame retardancy, and often adversely affect properties, such as resulting in a decrease in mechanical strength, degradation of heat resistance, etc. Thus, a bromine flame retardant and antimony trioxide are preferably used in combination as the flame retardant. In particular, 20 to 50 parts by mass of a bromine flame retardant and 5 to 25 parts by mass of antimony trioxide are preferably blended relative to 100 parts by mass of the resin. A commercially available product such as SAYTEX 8010 can be used as the bromine flame retardant.

The crosslinking aid content in the insulating resin composition of the first embodiment is 1 to 5 parts by mass relative to 100 parts by mass of the resin. When the crosslinking aid content is less than 1 part by mass, crosslinking does not proceed sufficiently and mechanical strength of the insulating layer decreases. A crosslinking aid content exceeding 5 parts by mass is not preferable since the crosslinking density increases excessively, resulting in high hardness and less flexibility. Examples of the crosslinking aid include isocyanurates such as triallyl isocyanurate (TAIC) and diallyl monoglycidyl isocyanurate (DA-MGIC), and trimethylol propane trimethacrylate. These can be used alone or in combination. Among these, trimethylol propane trimethacrylate is preferable to achieve effective crosslinking

Other components can be added to the insulating resin composition of the first embodiment if needed as long as the gist of the present invention is not impaired. Examples of the other components include a lubricant, a process aid, a coloring agent, and an antioxidant. Examples of the antioxidant include sulfur antioxidants and phenolic antioxidants. Adding 10 to 40 parts by mass of the antioxidant to 100 parts by mass of the resin can effectively suppress oxidation degradation of the resin within the range that does not impair the gist of the present invention, and is thus preferable.

The insulating resin composition of the first embodiment is produced by kneading the above-described essential components and optional components. Various known means can be used as the kneading method. As a kneading device, a single-screw extruder, a twin-screw extruder, a Banbury mixer, a kneader, a roll mill, and other known kneading devices can be used. A method that includes preliminarily conducting pre-blending by using a high-speed mixing machine such as a Henschel mixer or the like, and then conducting kneading by using the above-described kneading device may also be employed.

A second embodiment of the present invention is a crosslinked body obtained by crosslinking a resin composition mainly containing a polyolefin resin, the crosslinked body having a 2% secant modulus of 35 MPa or less at room temperature (for example, 25° C.) and an elastic modulus at 150° C. of 2 MPa or more.

The crosslinked body is obtained by crosslinking a resin composition mainly containing a polyolefin resin, and an example of the resin composition mainly containing a polyolefin resin is the insulating resin composition of the first embodiment. An example of the crosslinking method is a method of irradiating the resin composition with an ionizing radiation, and examples of the ionizing radiation include an electromagnetic wave such as a γ ray and an X ray, and a particle beam. An electron beam is preferable since high-energy irradiation is possible with a relatively inexpensive machine and irradiation is easy to control. The insulating resin composition of the first embodiment can be crosslinked by electron beam irradiation at high beam speed and thus is preferable as a raw material of the crosslinked body of the second embodiment.

When this crosslinked body is used as the insulating layer of an insulated electric wire, an insulated electric wire that has good flexibility enabling easy routing as well as excellent long-term heat resistance (heat life) can be produced. When a terminal of this insulated electric wire is to be used as a connector, good waterproof performance (terminal waterproofness) is exhibited. Good flexibility, excellent heat life, and excellent waterproof performance are not obtained if a crosslinked body having a 2% secant modulus exceeding 35 MPa at room temperature or an elastic modulus less than 2 MPa at 150° C. is used.

The crosslinked body achieves further improved creep deformation resistance and better waterproof performance when the ratio (150° C. elastic modulus/180° C. elastic modulus) of the elastic modulus at 150° C. to the elastic modulus at 180° C. is 1.2 or less. Thus, as a preferable embodiment, a crosslinked body in which the ratio of the elastic modulus at 150° C. to the elastic modulus at 180° C. is 1.2 or less is provided.

The 2% secant modulus is a value obtained by pulling a test specimen 100 mm in length in a length direction at a tensile rate of 50 mm/min using a tensile tester to find a load at 2% elongation, dividing this load by a cross-sectional area, and multiplying the result by 50. The elastic modulus at 150° C. and the elastic modulus at 180° C. are each determined as a value of a storage modulus in dynamic viscoelasticity measurement (frequency: 10 Hz, strain: 0.08%).

A third embodiment of the present invention is an insulated electric wire that includes a conductor and an insulating layer covering the conductor either directly or with another layer therebetween, in which the insulating layer is formed of the insulating resin composition of the first embodiment with the resin being crosslinked, or is formed of the crosslinked body of the second embodiment. This embodiment provides an insulated electric wire that has good flexibility and heat life that can meet the recent needs described above as well as good waterproof performance.

The insulated electric wire of the third embodiment encompasses not only a single insulated electric wire that includes a conductor and an insulating layer covering the conductor but also a bundle of plural insulated electric wires, etc. An example of the bundle of plural insulated electric wires is a wire harness used in wiring in automobiles. The type and structure of the insulated electric wire are not limited, and examples thereof include single strands, flat wires, and shield wires.

The conductor of the insulated electric wire is made of metal, such as copper or aluminum, and is in the form of a long line. The number of conductor may be 1, or more than 1.

The conductor is coated with an insulating layer formed of the insulating resin composition of the first embodiment or an insulating layer formed of the crosslinked body of the second embodiment. In the third embodiment, the conductor may be directly covered or may be covered with another layer therebetween. An example of the insulating layer that covers the conductor with another layer therebetween is a sheath layer that covers the outer side of a conductor layer formed on the outer side of an insulated electric wire.

When the insulating layer is formed of the insulating resin composition of the first embodiment, the outer side of the conductor is directly coated with the insulating resin composition of the first embodiment or the outer side of another layer that covers the conductor is coated by using the insulating resin composition of the first embodiment, and then the resin is crosslinked. Crosslinking of the resin is performed as in the production of the crosslinked body of the second embodiment. In other words, an insulating layer produced by forming a coating with the insulating resin composition of the first embodiment and then crosslinking the resin is formed of the crosslinked body of the second embodiment.

The coating formed of the insulating resin composition of the first embodiment can be formed by various known means, such as typical extrusion molding of an insulated electric wire. For example, a single-screw extruder having a cylinder diameter ϕ of 20 mm to 90 mm with L/D=10 to 40 can be used.

A wire harness is obtained by binding together plural insulated electric wires. For example, a connector is attached to a terminal of a single strand of an insulated electric wire or terminals of insulated electric wires of a wire harness or the like. The connector fits into a connector of another electronic device, and the insulated electric wire transmits power, control signals, etc., to the electronic device.

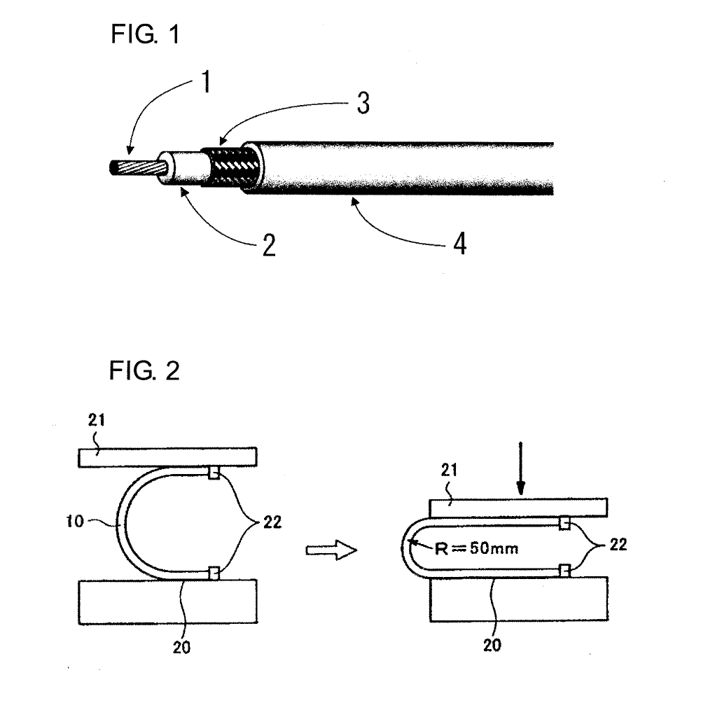

FIG. 1 is a perspective (partially cut-away) view of a structure of an example (shield electric wire) of the insulated electric wire of the third embodiment. In the drawing, 1 denotes a conductor. In this example, the conductor 1 is a stranded wire including plural strands. In the drawing, 2 denotes an insulating layer that directly covers the conductor 1, and 3 denotes a shield layer that is formed of a mesh of a conductive (or semi-conductive) material and blocks the influence of the outside electromagnetic waves. In this example, the outer side of the shield layer 3 is also coated with an insulating layer (sheath) 4.

The insulating resin composition of the first embodiment and the crosslinked body of the second embodiment can be used to form the insulating layer 2 that directly covers the conductor 1 and also can be used to form the insulating layer (sheath) 4 that covers the conductor 1 with another layer, e.g., the insulating layer 2, therebetween.

### EXAMPLES

First, the raw materials used in blend examples are described.

[Resin composition]
(First copolymer)
EB (density: 0.862 g/cm³):

ENGAGE 7467 (produced by the Dow Chemical Company, denoted as “EB1” in the tables)

EB (density: 0.880 g/cm³):

ENGAGE 7277 (produced by the Dow Chemical Company, denoted as “EB2” in the tables)

EB (density: 0.870 g/cm³):

TAFMER DF710 (produced by Mitsui Chemicals, Inc., denoted as “EB3” in the tables)

Ethylene-octene copolymer (EO) (density: 0.857 g/cm³)

ENGAGE 8842 (produced by the Dow Chemical Company, denoted as “EO” in the tables)

Ethylene-propylene copolymer (EP) (density: 0.875 g/cm³) :

ENGAGE ENR6386 (produced by the Dow Chemical Company, denoted as “EP” in the tables)

(Second copolymer)
EEA (EA 23%): NUC-6510 (produced by Nippon Unicar Company Limited)
(Resins and vulcanizing agents used for comparison)
Silicone rubber: KE-5634-U (produced by Shin-Etsu Silicones)
EP rubber: ESPRENE 301 (produced by Sumitomo Chemical Co., Ltd.)
Vulcanizing agent: C-25A and C-25B (produced by Shin-Etsu Silicones), and PERCUMYL D (produced by NOF CORPORATION)
(Flame retardant)
Bromine flame retardant: SAYTEX 8010
Antimony trioxide

### (Antioxidant)

Sulfur antioxidant: SUMILIZER MB (produced by Sumitomo Chemical Co., Ltd.)
Phenolic antioxidant: IRGANOX 1010 (produced by BASF)
Sulfur antioxidant: IRGANOX PS802 (produced by BASF)
(Crosslinking aid)
Trimethylol propane trimethacrylate (produced by DIC Corporation: TD1500s)
(Other components) Zinc oxide
[Electric wire structure]

Conductor, 15 sq: Thirty 0.18 mm strands were stranded into a stranded wire, and nineteen stranded wires prepared as such were stranded into a double-stranded structure.

Outer diameter of conductor: 5.5 mm, insulating layer: 1.25 mm in thickness, outer diameter of electric wire: 8 mm

### (Experiment)

Each of the resin compositions mixed at blend ratios shown in Table 1 to 5 was extruded onto the conductor to form an insulating layer having the aforementioned thickness and covering the conductor. As a result, an insulated electric wire having the above-described electric wire structure was obtained. The resin was crosslinked by irradiation with a 240 kGy electron beam, and then the heat life, 2% secant modulus, elastic moduli (150° C. and 180° C.), flexibility (flexural rigidity), and waterproof performance of the insulated electric wire were evaluated through the following procedures. For comparison, each of resin compositions mixed at blend ratios shown in Table 6 by using silicone rubber and EP rubber was extruded onto the conductor to form an insulating layer having the aforementioned thickness and covering the conductor, and then vulcanized so as to obtain an insulated electric wire having the above-described electric wire structure. Evaluation was conducted in the same manner.

[Procedure for evaluating heat life]

Heat resistance was rated on the basis of a continuous heat resistance temperature according to a Japanese Automobile Standard (JASO). Specifically, an ageing test was conducted at temperatures of 170° C., 180° C., 190° C., and 200° C., the time taken for tensile elongation to fall below 100% was measured, and an Arrhenius plot was made to determine the temperature (continuous heat resistance temperature) at which 100% elongation is secured in 10,000 hours. The result was assumed to be the heat life. The heat life is preferably 150° C. or higher and more preferably 151° C. or higher.

[Procedure for measuring 2% secant modulus]

A test specimen 100 mm in length was pulled in the length direction at a tensile rate of 50 mm/min using a tensile tester, and a load at 2% elongation was determined. The load was then divided by a cross-sectional area, and the result was multiplied by 50 to obtain a 2% secant modulus value (MPa).

[Procedure for measuring elastic moduli (150° C.·180° C.)]

The storage modulus was determined at each temperature by dynamic viscoelasticity measurement (frequency: 10 Hz, strain: 0.08%).

[Procedure for evaluating flexibility (flexural rigidity)]

The flexibility of the insulated electric wire was rated in accordance with IEC 60794-1-2 Method 17c by a procedure shown in FIG. 2. That is, an insulated electric wire 10 is placed between a fixed surface 20 and a plate 21 parallel to the fixed surface 20 so as to bend the insulated electric wire 10 180°, and ends of the insulated electric wire 10 are fixed with fixing members 22. A load cell is placed on the plate 21 and the load applied until the bend radius reaches 50 mm is measured to determine the flexural rigidity (N·mm²). The test is conducted at room temperature. The flexural rigidity is acceptable as long as it is 18 N·mm² or lower but is preferably 16 N·mm² or lower.

[Procedure for evaluating waterproof performance]

A ring-shaped waterproof silicone rubber plug having an inner diameter that can be made 20% smaller than the outer diameter of the electric wire is prepared and attached to the outer periphery of the electric wire having the electric wire structure described above. A connector housing is formed outside to form a waterproof connector. The waterproof connector is placed in a heat resistance tester at 150° C. for 1500 hours, terminal ends of the housing are sealed, and 0.2 MPa compressed air is fed from the rear end of the electric wire in water so as to check whether bubbles come from the waterproof rubber plug. The samples with which no bubbles are observed are rated “Good” and the samples with which bubbles are observed are rated “Poor”. The results are shown in Tables 1 to 6.

TABLE 1

| | | Blend | Blend | Blend | Blend | Blend |
|---|---|---|---|---|---|---|
| | | Exam- | Exam- | Exam- | Exam- | Exam- |
| | | ple 1 | ple 2 | ple 3 | ple 4 | ple 5 |
| First | EB1 (density | — | 20 | 30 | 40 | 50 |
| copolymer | 0.862 g/cm³) | | | | | |
| Second | EEA | 100 | 80 | 70 | 60 | 50 |
| copolymer | | | | | | |
| Flame | Bromine | 35 | 35 | 35 | 35 | 35 |
| retardant | flame | | | | | |
| | retardant | | | | | |
| | Antimony | 10 | 10 | 10 | 10 | 10 |
| | trioxide | | | | | |
| Zinc oxide | | 10 | 10 | 10 | 10 | 10 |
| Anti- | SUMILIZER | 10 | 10 | 10 | 10 | 10 |
| oxidant | MB | | | | | |
| | IRGANOX | 4 | 4 | 4 | 4 | 4 |
| | 1010 | | | | | |
| | IRGANOX | 2 | 2 | 2 | 2 | 2 |
| | PS802 | | | | | |

| | | | | | |
|---|---|---|---|---|---|
| Crosslinking aid | 3 | 3 | 3 | 3 | 3 |
| Electron beam | 240 | 240 | 240 | 240 | 240 |
| dose (kGy) | | | | | |
| Heat life (° C.) | 152 | 152 | 152 | 151 | 151 |
| 2% secant | 39 | 37 | 36 | 30 | 25 |
| modulus (MPa) | | | | | |
| Elastic modulus at | 1.4 | 1.7 | 1.8 | 2.0 | 2.4 |
| 150° C. (MPa) | | | | | |
| Elastic modulus ratio | 1.3 | 1.3 | 1.25 | 1.2 | 1.15 |
| (150° C./180° C.) | | | | | |
| Flexural rigidity | 22 | 20 | 19 | 18 | 15 |
| (N · mm²) | | | | | |
| Waterproof performance | Poor | Poor | Poor | Good | Good |

TABLE 2

| | | Blend | Blend | Blend | Blend | Blend |
|---|---|---|---|---|---|---|
| | | Exam- | Exam- | Exam- | Exam- | Exam- |
| | | ple 6 | ple 7 | ple 8 | ple 9 | ple 10 |
| First | EB1 (density | 60 | 70 | 80 | 90 | 100 |
| copolymer | 0.862 g/cm³) | | | | | |
| Second | EEA | 40 | 30 | 20 | 10 | — |
| copolymer | | | | | | |
| Flame | Bromine | 35 | 35 | 35 | 35 | 35 |
| retardant | flame | | | | | |
| | retardant | | | | | |
| | Antimony | 10 | 10 | 10 | 10 | 10 |
| | trioxide | | | | | |
| Zinc oxide | | 10 | 10 | 10 | 10 | 10 |
| Anti- | SUMILIZER | 10 | 10 | 10 | 10 | 10 |
| oxidant | MB | | | | | |
| | IRGANOX | 4 | 4 | 4 | 4 | 4 |
| | 1010 | | | | | |
| | IRGANOX | 2 | 2 | 2 | 2 | 2 |
| | PS802 | | | | | |

| | | | | | |
|---|---|---|---|---|---|
| Crosslinking aid | 3 | 3 | 3 | 3 | 3 |
| Electron beam | 240 | 240 | 240 | 240 | 240 |
| dose (kGy) | | | | | |
| Heat life (° C.) | 151 | 151 | 150 | 148 | 146 |
| 2% secant | 23 | 20 | 18 | 16 | 14 |
| modulus (MPa) | | | | | |
| Elastic modulus at | 2.6 | 2.7 | 2.8 | 2.9 | 3.0 |
| 150° C. (MPa) | | | | | |
| Elastic modulus ratio | 1.15 | 1.1 | 1.1 | 1.05 | 1.05 |
| (150° C./180° C.) | | | | | |
| Flexural rigidity | 14 | 13 | 12 | 10 | 9 |
| (N · mm²) | | | | | |
| Waterproof performance | Good | Good | Good | Good | Good |

TABLE 3

| | | Blend | Blend | Blend | Blend | Blend |
|---|---|---|---|---|---|---|
| | | Exam- | Exam- | Exam- | Exam- | Exam- |
| | | ple 11 | ple 12 | ple 13 | ple 14 | ple 15 |
| First | EB1 (0.862) | 100 | — | — | — | — |
| copolymer | EB2 (0.880) | — | 100 | — | — | — |
| Density | EB3 (0.870) | — | — | 100 | — | — |
| g/cm³ is in | EO (0.857) | — | — | — | 100 | — |
| paren- | EP (0.875) | — | — | — | — | 100 |
| theses | | | | | | |
| Second | EEA | — | — | — | — | — |
| copolymer | | | | | | |
| Flame | Bromine | 35 | 35 | 35 | 35 | 35 |
| retardant | flame | | | | | |
| | retardant | | | | | |
| | Antimony | 10 | 10 | 10 | 10 | 10 |
| | trioxide | | | | | |
| Zinc oxide | | 10 | 10 | 10 | 10 | 10 |
| Anti- | SUMILIZER | 10 | 10 | 10 | 10 | 10 |
| oxidant | MB | | | | | |
| | IRGANOX | 4 | 4 | 4 | 4 | 4 |
| | 1010 | | | | | |
| | IRGANOX | 2 | 2 | 2 | 2 | 2 |
| | PS802 | | | | | |

| | | | | | |
|---|---|---|---|---|---|
| Crosslinking aid | 3 | 3 | 3 | 3 | 3 |
| Electron beam | 240 | 240 | 240 | 240 | 240 |
| dose (kGy) | | | | | |
| Heat life (° C.) | 150 | 152 | 151 | 150 | 140 |
| 2% secant | 12 | 38 | 22 | 10 | 36 |
| modulus (MPa) | | | | | |
| Elastic modulus at | 3.0 | 1.9 | 2.4 | 2.7 | 1.5 |
| 150° C. (MPa) | | | | | |
| Elastic modulus ratio | 1.05 | 1.30 | 1.10 | 1.10 | 1.30 |
| (150° C./180° C.) | | | | | |
| Flexural rigidity | 10 | 22 | 15 | 9 | 21 |
| (N · mm²) | | | | | |
| Waterproof performance | Good | Poor | Good | Good | Good |

TABLE 4

| | | Blend | Blend | Blend | Blend | Blend |
|---|---|---|---|---|---|---|
| | | Exam- | Exam- | Exam- | Exam- | Exam- |
| | | ple 16 | ple 17 | ple 18 | ple 19 | ple 20 |
| First | EB1 (density | 90 | 80 | 70 | 60 | 50 |
| copolymer | 0.862 g/cm³) | | | | | |
| Second | EEA | 10 | 20 | 30 | 40 | 50 |
| copolymer | | | | | | |
| Flame | Bromine | 35 | 35 | 35 | 35 | 35 |
| retardant | flame | | | | | |
| | retardant | | | | | |
| | Antimony | 10 | 10 | 10 | 10 | 10 |
| | trioxide | | | | | |
| Zinc oxide | | 10 | 10 | 10 | 10 | 10 |
| Anti- | SUMILIZER | 10 | 10 | 10 | 10 | 10 |
| oxidant | MB | | | | | |
| | IRGANOX | 4 | 4 | 4 | 4 | 4 |
| | 1010 | | | | | |
| | IRGANOX | 2 | 2 | 2 | 2 | 2 |
| | PS802 | | | | | |

| | | | | | |
|---|---|---|---|---|---|
| Crosslinking aid | 3 | 3 | 3 | 3 | 3 |
| Electron beam | 240 | 240 | 240 | 240 | 240 |
| dose (kGy) | | | | | |
| Heat life (° C.) | 150 | 150 | 150 | 151 | 151 |
| 2% secant | 13 | 15 | 18 | 20 | 22 |
| modulus (MPa) | | | | | |
| Elastic modulus at | 2.9 | 2.8 | 2.8 | 2.6 | 2.3 |
| 150° C. (MPa) | | | | | |
| Elastic modulus ratio | 1.05 | 1.10 | 1.10 | 1.15 | 1.15 |
| (150° C./180° C.) | | | | | |
| Flexural rigidity | 10 | 11 | 13 | 14 | 15 |
| (N · mm²) | | | | | |
| Waterproof performance | Good | Good | Good | Good | Good |

TABLE 5

| | | Blend | Blend | Blend | Blend | Blend |
|---|---|---|---|---|---|---|
| | | Exam- | Exam- | Exam- | Exam- | Exam- |
| | | ple 21 | ple 22 | ple 23 | ple 24 | ple 25 |
| First | EB1 (density | 40 | 30 | 20 | 10 | — |
| copolymer | 0.862 g/cm³) | | | | | |
| Second | EEA | 60 | 70 | 80 | 90 | 100 |
| copolymer | | | | | | |
| Flame | Bromine | 35 | 35 | 35 | 35 | 35 |
| retardant | flame | | | | | |
| | retardant | | | | | |
| | Antimony | 10 | 10 | 10 | 10 | 10 |
| | trioxide | | | | | |
| Zinc oxide | | 10 | 10 | 10 | 10 | 10 |
| Anti- | SUMILIZER | 10 | 10 | 10 | 10 | 10 |
| oxidant | MB | | | | | |
| | IRGANOX | 4 | 4 | 4 | 4 | 4 |
| | 1010 | | | | | |
| | IRGANOX | 2 | 2 | 2 | 2 | 2 |
| | PS802 | | | | | |

| | | | | | |
|---|---|---|---|---|---|
| Crosslinking aid | 3 | 3 | 3 | 3 | 3 |
| Electron beam | 240 | 240 | 240 | 240 | 240 |
| dose (kGy) | | | | | |
| Heat life (° C.) | 151 | 152 | 152 | 152 | 152 |
| 2% secant | 25 | 28 | 32 | 35 | 37 |
| modulus (MPa) | | | | | |
| Elastic modulus at | 2 | 1.8 | 1.6 | 1.5 | 1.4 |
| 150° C. (MPa) | | | | | |
| Elastic modulus ratio | 1.2 | 1.25 | 1.30 | 1.30 | 1.40 |
| (150° C./180° C.) | | | | | |
| Flexural rigidity | 16 | 17 | 18 | 20 | 22 |
| (N · mm²) | | | | | |
| Waterproof performance | Good | Poor | Poor | Poor | Poor |

TABLE 6

| | | Blend | Blend |
|---|---|---|---|
| | | Exam- | Exam- |
| | | ple 26 | ple 27 |
| Silicone rubber KE-5634-U | | 100 | — |
| Vulcanizing agent C-25A | | 1 | — |
| Vulcanizing agent C-25B | | 2 | — |
| EP rubber ESPRENE 301 | | — | 100 |
| Vulcanizing agent PERCUMYL D | | — | 3 |
| Flame | Bromine | — | 35 |
| retardant | flame | | |
| | retardant | | |
| | Antimony | — | 10 |
| | trioxide | | |
| Zinc oxide | | — | 10 |
| Anti- | SUMILIZER | — | 10 |
| oxidant | MB | | |
| | IRGANOX | — | 4 |
| | 1010 | | |
| | IRGANOX | — | 2 |
| | PS802 | | |

| | | |
|---|---|---|
| Heat life (° C.) | 160 | 130 |
| 2% secant | 10 | 15 |
| modulus (MPa) | | |
| Elastic modulus at | 5.0 | 3.0 |
| 150° C. (MPa) | | |
| Elastic modulus ratio | 1.05 | 1.40 |
| (150° C./180° C.) | | |
| Flexural rigidity | 9 | 11 |
| (N · mm²) | | |
| Waterproof performance | Good | Poor |

As shown in Table 3, Blend Examples 11, 13, and 14, in which a copolymer of ethylene and EB or EO, i.e., an unsaturated hydrocarbon having 4 or more carbon atoms, the copolymer having a density less than 0.88 g/cm³, is used as the first copolymer, have good heat life, a 2% secant modulus far lower than 35 MPa, an elastic modulus exceeding 2.0 MPa at 150° C., an elastic modulus ratio (150° C./180° C.) smaller than 1.2, and satisfactory waterproof performance. Moreover, flexural rigidity is small and flexibility is excellent.

In contrast, Blend Example 15 in which a copolymer of ethylene and EP, i.e., an unsaturated hydrocarbon having 3 carbon atoms, is used as the first copolymer has a 2% secant modulus exceeding 35 MPa, an elastic modulus less than 2.0 MPa at 150° C., and an elastic modulus ratio (150° C./180° C.) exceeding 1.2. Although the waterproof performance is good, the heat life is low and the recent needs are not satisfied. The flexural rigidity is also large and the flexibility is poor.

In Blend Example 12 in which a copolymer of ethylene and EB, which is an unsaturated hydrocarbon having 4 carbon atoms, is used as the first copolymer but the density of the copolymer is 0.88 g/cm³, the 2% secant modulus exceeds 35 MPa, the elastic modulus at 150° C. is less than 2.0 MPa, the elastic modulus ratio (150° C./180° C.) exceeds 1.2, and the waterproof performance is poor. Moreover, flexural rigidity is large and flexibility is poor. These results show that a polyolefin resin which is a copolymer of ethylene and an unsaturated hydrocarbon having 4 or more carbon atoms and has a density less than 0.88g/cm³ must be used as the first copolymer.

As shown in Tables 1, 2, 4, and 5, in Blend Examples 4 to 10 and Blend Examples 16 to 21 in which the first copolymer-to-second copolymer ratio (mass ratio) is within the range of 100:0 to 40:60, the heat life is good, the 2% secant modulus is lower than 35 MPa, the elastic modulus at 150° C. is 2.0 MPa or more, the elastic modulus ratio (150° C./180° C.) is 1.2 or less, and satisfactory waterproof performance is obtained. Moreover, flexural rigidity is small and flexibility is excellent.

In contrast, in Blend Examples 1 to 3 and Blend Examples 22 to 25 in which the mass ratio of the first copolymer relative to the total mass of the first copolymer and the second copolymer is less than 40%, the elastic modulus at 150° C. is less than 2.0 MPa, the elastic modulus ratio (150° C./180° C.) exceeds 1.2, and the waterproof performance is poor. In some samples, the 2% secant modulus exceeds 35 MPa, flexural rigidity is large, and flexibility is poor. These results show that the first copolymer-to-second copolymer ratio (mass ratio) needs to be within the range of 100:0 to 40:60.

Tables 1 and 2 show that in Blend Examples 9 and 10 in which the mass ratio of the second copolymer relative to the total mass of the first copolymer and the second copolymer exceeds 80%, the heat life is lower than 150° C. and the long-term heat resistance (heat-aging resistance) is inferior to Blend Examples 4 to 8 in which the mass ratio does not exceed 80%. These results show that the first copolymer-to-second copolymer ratio (mass ratio) is preferably within the range of 80:20 to 40:60.

The results in Table 6 show that in Blend Example 27 in which EP rubber is used to form the insulating layer, the heat life and waterproof performance are inferior. In contrast, in Blend Example 26 in which silicone rubber is used to form the insulating layer, the heat life and waterproof performance are good. However, use of silicone rubber raises concerns such as low mechanical strength, high raw material cost, poor oil resistance, possibility of contact faults due to low-molecular-weight siloxane components, etc.

### REFERENCE SIGNS LIST

1 conductor

2 insulating layer

3 shield layer

4 insulating layer (sheath)

10 insulated electric wire

20 fixed surface

21 plate

22 fixing member

1-8. (canceled).

9. An insulated electric wire comprising a conductor and an insulating layer covering the conductor either directly or with another layer therebetween,
wherein the insulating layer is formed of an insulating resin composition,
the insulating resin composition comprises a resin comprising a first copolymer and a second copolymer at a first copolymer-to-second copolymer ratio (mass ratio) of 100:0 to 40:60,
the first copolymer is a copolymer of ethylene and an unsaturated hydrocarbon having 4 or more carbon atoms, and has a density less than 0.88 g/cm³,
the second copolymer is a copolymer of ethylene and an acrylic acid ester or a methacrylic acid ester,
the insulating resin composition comprises 30 to 100 parts by mass of a flame retardant and 1 to 5 parts by mass of a crosslinking aid relative to 100 parts by mass of the resin, and
the resin is crosslinked.

10. The insulated electric wire according to claim 9, wherein the first copolymer is an ethylene-butene copolymer.

11. The insulated electric wire according to claim 9, wherein the second copolymer is an ethylene-ethyl acrylate copolymer.

12. The insulated electric wire according to claim 9, wherein the ratio of the first copolymer to the second copolymer is 80:20 to 40:60.
